(19) United States
(12) Patent Application Publication
(10) Pub. No.: US 2022/0131178 A1
(43) Pub. Date: Apr. 28, 2022

(54) BATTERY MODULE

(71) Applicant: Robert Bosch GmbH, Stuttgart (DE)

(72) Inventors: Dennis Mehlo, Taipei (TW); Lisa Bayer, Stuttgart (DE); Peter Kunert, Lichtenstein (DE)

(21) Appl. No.: 17/452,179

(22) Filed: Oct. 25, 2021

(30) Foreign Application Priority Data
Oct. 27, 2020 (DE) 10 2020 213 475.8

(51) Int. Cl. H01M 10/04; H01M 50/209

(52) U.S. Cl. CPC H01M 10/0481; H01M 50/209

(57) ABSTRACT

A battery module comprising a plurality of stacks. Each stack comprises at least one cell holder and multiple battery cells. Each cell holder is designed to accommodate the battery cells of the respective stack. Pressing elements on opposite end faces of the cell holder abut both on the cell holder as well as on the battery cells and exert a force of pressure at least on the battery cells along a pressing direction. The stacks are situated adjoining along the pressing direction and are press-fitted along the pressing direction.

### CROSS REFERENCE

The present application claims the benefit under 35 U.S.C. 119 of German Patent Application No. DE 102020213475.8 filed on Oct. 27, 2020, which is expressly incorporated herein by reference in its entirety.

### FIELD

The present invention relates to a battery module. Multiple battery cells are braced with one another in this battery module.

### BACKGROUND INFORMATION

In some conventional battery modules in the related art, a plurality of individual battery cells are interconnected. The individual battery cells must be mechanically fixed in position, in particular in order to avoid damage to the individual cells.

Battery modules are used for example in electrically driven bicycles. In such an application, the battery module may be subjected to shock loads, for example due to an uneven subsurface during the travel operation or due to the user dropping the battery module during installation on or removal from the bicycle. These shock loads may be absorbed by press-fitting the battery cells in order thus to avoid damage to the individual battery cells.

### SUMMARY

A battery module according to has example embodiment of the present invention has an optimized bracing concept for the individual battery cells. For this purpose, individual magazines, also known as stacks, are formed, a flux of force being partitioned between an internal fixation and an external fixation.

The battery module thus has a plurality of stacks, each stack comprising at least one cell holder and multiple battery cells. The cell holder receives the battery cells of the respective stack. Pressing elements are provided at opposite end faces of the cell holder, these pressing elements abutting both on the cell holder as well as on the battery cells. The pressing elements are designed to exert a force of pressure on the battery cells along a pressing direction. The individual stacks are arranged adjoining along the pressing direction and are press-fitted along the pressing direction.

When the stacks are press-fitted, a force of pressure is also applied on the respective pressing elements, which in turn results in the cell holder and the battery cells being pressed. Due to the design of the pressing elements, a predefined force of pressure is exerted on the battery cells. This force of pressure cannot rise arbitrarily since upon reaching the predefined force of pressure, the cell holder would also have to be pressed. The cell holder thus prevents the force of pressure on the individual battery cells from rising arbitrarily and thus limits the latter. At the same time, however, all stacks are to be press-fitted by a force of pressure that is essentially independent of the force of pressure of the individual battery cells. In other words, the flux of force is partitioned into an inner flux and an outer flux. The inner flux is achieved by the pressing elements, the battery cells and the cell holders. The outer flux occurs between the individual stacks and thereby in particular independently of the individual battery cells.

Particularly advantageously, a tolerance adjustment may be achieved in this manner. The tolerances of the battery cells along the pressing direction are often relatively large. On account of the use of the pressing elements, as described above, a tolerance adjustment occurs already on these pressing elements. In particular, this prevents tolerances of the battery cells from accumulating along the pressing direction. Thus solely tolerances between the individual stacks need to be compensated when these stacks are press-fitted. The tolerances between the stacks are independent of the tolerances of the battery cells, so that a tolerance adjustment is simple to perform and without great expenditure. Partitioning the tolerances analogous to the flux of force thus ensures that a predefined force of pressure on the battery cells may be achieved safely and reliably, without exceeding critical values.

If a mechanical load is applied, for example a mechanical shock load, forces are not exchanged between the battery cells. Rather, the shock forces per battery cell are dissipated by the respectively associated cell holder and pressing elements. An accumulation of mass inertias and acting forces, which would occur without partitioning the flux of force, is thus avoided. A mechanical overloading of individual battery cells, in particular at the edge of the battery module is thus excluded.

Finally, a functional separation is achieved, which ensures a maintenance of a force of pressure on the battery cells even over long service lives. Thus, a settling of the press-fitted battery cells does not necessarily result in a decline of the force of pressure on the battery cells since the force of pressure of the battery cells is set by the pressuring elements. In the event of a settling of the pressing elements and/or cell holders and/or of the elements provided for press-fitting the stacks, a force of pressure on the battery cells continues to exist. Thus, a desired force on the battery cells is maintained.

Preferred developments of the present invention are disclosed herein.

In accordance with an example embodiment of the present invention, it is preferably provided for a stiffness of the cell holder along the pressing direction to be greater than a stiffness of the battery cells along the pressing direction. This makes it possible to set the flux of force in the battery module in optimized fashion, in particular to split it into a flux of force within the stacks and a flux of force across the stacks. The greater stiffness of the cell holder makes it possible to dissipate a pressing force across the stacks through the cell holders. The pressing of the battery cells thus occurs independently and solely within each stack.

The pressing elements preferably each have at least one first area and one second area. The cell holder abuts only on the first area. The battery cells, on the other hand, abut only on the second area. The first area has a greater stiffness than the second area. A partitioning of the forces thus occurs due to the preferred partitioning of the pressing elements into the first area and the second area. The second areas of the pressing elements ensure the internal flux of force within the stacks. For this purpose, a pressing force is applied on the battery cells by way of the second areas. In addition, an application of an external flux of force across the stacks is made possible by the first areas, since the first areas abut on the cell holders. It is thus possible to conduct a force across the stacks through the first areas and through the cell holders.

A particularly preferred embodiment of the present invention provides for the pressing elements to be respectively developed in such a way that when the first area abuts on the cell holder, the second area exerts a force on the battery cells. This force is in particular an elastic restoring force. This may be implemented in particular in that the geometry of first areas and second areas is designed accordingly so that when the first area abuts on the cell holder, said force is exerted on the battery cells. When installing the pressing elements, it is thus possible to ensure that a contact between the second area and the battery cells occurs before a contact between the first area and the cell holder can be established. If the first area is applied on the cell holder, then a compression of the second area and/or of the battery cells occurs, for example. A suitably varied design of the first area and the second area makes it possible in this manner to set a maximum force of pressure on the battery cells, which is always achieved when the first area abuts on the cell holder. The pressing force on the battery cells cannot be increased further by the first area abutting on the cell holder, regardless of what external forces act on the pressing elements. Thus it is possible advantageously to implement the above-described partitioning of the flux of force.

Preferably, in accordance with an example embodiment of the present invention, it is also provided that only the first area of each pressing element abuts on an adjacent stack. Thus, for contact between the stacks, only a contact between the first areas of the pressing elements is provided. In particular, a transfer of force from one stack to an adjacent stack is thus not possible via the second area. A transfer of force must thus occur always via the first area, whereby in turn the above-described partitioning of the flux of force is achieved.

A further preferred development of the present invention provides for only one pressing element to be situated between two cell holders of two stacks. The pressing element has a first area and two second areas separated by the first area. It is again provided for the second areas to be in contact only with the battery cells, while the first area is in contact, not with the battery cells, but instead with the cell holders of the adjacent stacks. Using a single pressing element, it is thus possible to achieve the partitioning of force between the internal flux of force and the external flux of force in the case of two neighboring stacks. The same effect may be achieved by applying instead two pressing elements against each other, each pressing element having a single first area and a single second area.

The first area is particularly advantageously developed in such a way that it has a recess. The second area is situated in this recess. The first area is thus provided in particular in an outer edge area, at which the cell holder is also situated. The second area is located within the outer edge area, since the battery cells are also situated at this location. Furthermore, the first area surrounds the second area at least in sections, so that a contact of other components, in particular of adjacent stacks, with the second area is avoided.

The pressing elements are preferably made from plastic. As described above, the partitioning into the first area and the second area provides for each of the areas to be made from plastic, preferably from different plastics. This makes it possible in particular to implement the above-described different firmnesses of the first area and the second area in a simple and reliable manner.

In accordance with an example embodiment of the present invention, the battery module advantageously has a tension rod. The tension rod is used to press-fit the stacks together. The tension rod thus makes it possible in a simple and reliable manner to set a desired force with which the individual stacks are to be pressed against one another. It is thus possible to set in particular the external flux of force across the stacks in a simple and reliable manner.

The tension rod is particularly advantageously provided between two end plates. The stacks are situated between these end plates. The end plates may be the pressing elements as above-described, although it is also possible to provide a separate pressing plate in each case, on which a corresponding pressing element abuts. The end plates may be made of a metallic material and/or of plastic.

### BRIEF DESCRIPTION OF THE DRAWINGS

Exemplary embodiments of the present invention are described in detail below with reference to the figures.

FIG. 1 is a schematic view of a functional principle of a battery module according to an exemplary embodiment of the present invention,

FIG. 2 is a schematic view of a battery module according to the exemplary embodiment of the present invention.

FIG. 3 is a schematic detail of the battery module according to the exemplary embodiment of the present invention.

### DETAILED DESCRIPTION OF EXAMPLE EMBODIMENTS

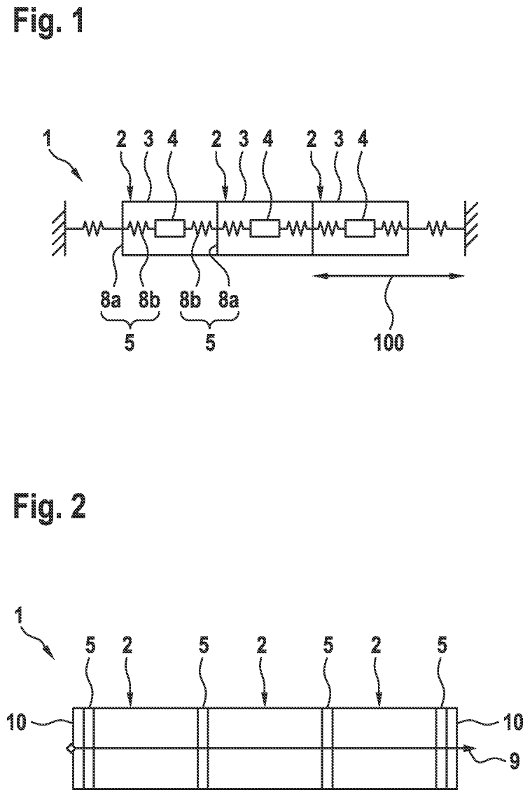

FIG. 1 shows schematically a functional principle of a battery module 1 according to an exemplary embodiment of the present invention. Battery module 1 has a plurality of battery cells 4, which are to be supported reliable within battery module 1. For this purpose, a flux of force is to be partitioned by providing a plurality of stacks 2. Each stack 2 comprises at least one battery cell 4, in particular a plurality of battery cells 4, as well as a cell holder 3. The battery cells 4 of stack 2 are accommodated in cell holder 3. Furthermore, a total of two pressing elements 5 are provided per stack 2. Pressing elements 5 in turn each have a first area 8a and a second area 8b, the first area 8a interacting with cell holder 3, while second area 8b interacts with battery cells 4. In this manner, second area 8b of pressing elements 5 exerts a force of pressure on battery cells 4. This pressing force is limited by the fact that first area 8a abuts on cell holder 3.

Such a construction makes it possible to press-fit stacks 2 together in order to achieve a firm hold of stacks 2. In addition, two battery cells 4 are press-fitted within each stack. A flux of force is partitioned into an internal flux of force within stacks 2 and an external flux of force across stacks 2. This is achieved in that the external flux of force runs across the first areas 8a of pressing elements 5 and cell holders 3. The internal flows of force within stacks 2, on the other hand, are achieved by the second areas 8b. Thus it is possible to set an optimized force of pressure for each battery cell 4. At the same time, an external force of pressure may be applied on stacks 2, which does not affect an internal force of pressure, however. In particular an overloading of battery cells 4 is thus avoided.

The aforementioned arrangement has the advantage that a tolerance adjustment is possible in a simple and economical manner. Battery cells 4 usually have great tolerances. These tolerances are not accumulated, however, as would be the case if multiple battery cells were arranged directly side by side along a pressing direction. Rather, a tolerance adjustment occurs already within the individual stacks 2. The tolerances of stacks 2 are formed by first areas 8a of pressing elements 5 as well as by cell holders 3, these tolerances consequently being lower than in the case of battery cells 4. This tolerance adjustment may be achieved by applying a suitable force of pressure along pressing direction 100.

FIG. 2 shows schematically the design of battery module 1 according to the exemplary embodiment of the present invention. In this exemplary embodiment, three stacks 2 are provided, each stack 2 having multiple battery cells 4.

Stacks 2 are arranged side by side along pressing direction 100. Furthermore, altogether two pressing elements 5 are associated with each stack 2, which are arranged between stacks 2 in pressing direction 100.

A tension rod 9 extending between two end plates 10 is provided for applying a force of pressure on stacks 2. End plates 10 may be designed along the lines of pressing elements 5 or alternatively may be merely plate-shaped elements on which additional pressing elements 5 abut. Other embodiments of end plates 10 are also possible.

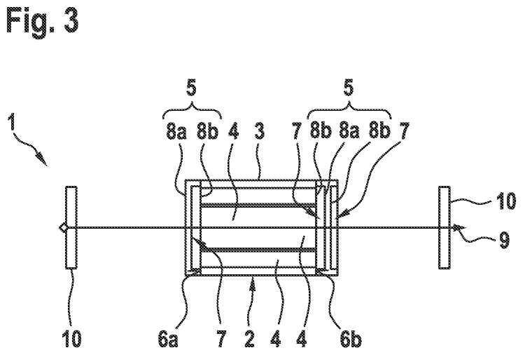

FIG. 3 shows the arrangement of a single stack 2 of battery module 1 as a detail view. Two different kinds of pressing elements 5 are shown by way of example, it being possible for each pressing element 5 to be used also in other positions.

On the left side of cell holder 3, FIG. 3 shows a pressing element 5, which has a first area 8a and a second area 8b. First area 8a has a recess 7, in which second area 8b is situated. Both the first area 8a as well as the second area 8b are made of plastic, a firmness of first area 8a being greater than a firmness of second area 8b. Likewise, a firmness of cell holder 3 is greater than a firmness of battery cells 4, at least in the pressing direction 100.

When first area 8a abuts on cell holder 3, this results in the application of an elastic restoring force on battery cells 4 by second area 8b. In addition, second area 8b and/or battery cells 4 are elastically deformed. Due to the design of first area 8a and of second area 8b, a predefined pressing force may be applied on battery cells 4. This force of pressure is limited by first area 8a abutting on cell holder 3 and a maximum deformation of battery cells 4 and/or second area 8b that is thereby limited. It is thus possible reliably to set a predefined force of pressure. At the same time, there occurs a tolerance adjustment of the lengths of battery cells 4 along pressing direction 100. A predefined force of pressure is thus able to act on each battery cell 4 in a safe and reliable manner, this also being ensured over the service life of battery module 1.

As shown in FIG. 3, second area 8b is able to come into contact merely with battery cells 4. First area 8a prevents second area 8b from coming into contact with other battery components, in particular with other stacks 2. Only first area 8a is provided for this purpose.

For press-fitting multiple stacks 2, a transfer of force occurs between the individual cell holders 3 of stacks 2 via first areas 8a. The flux of force running between stacks 2, also called the external flux of force, is thus unable to run through the battery cells 4 themselves. The force applied for press-fitting the stacks 2 is thus not relevant for the force of pressure of the individual battery cells 4. It is thus possible to set any force of pressure without running the risk of overloading battery cells 4.

A pressing element 5, as shown on the left side, may be used for each stack 2. In FIG. 3, this pressing element abuts on a first end face 6a of cell holder 3. This pressing element 5 may also respectively abut on the second end face 6b of cell holder 3. In such a case, each stack 2 would have two pressing elements 5, the first areas 6a of adjacent pressing elements 5 abutting on each other. Alternatively, a pressing element 5 may instead be used, as shown on the right side, which abuts on the second end face 6b of cell holder 3 in FIG. 3. In this case, pressing element 5 has two second areas 8b separated by first area 8a, each of the second areas 8b abutting on battery cells 4 of different stacks 4.

The force of pressure acting on individual battery cells 4 is independent of the force of pressure that is set via tension rod 9. The force of pressure on battery cells 4 is determined solely by pressing elements 5. A settling of the external fixation, that is, of tension rod 9 and of end plates 10, does not result in a reduction of the force of pressure within stacks 2. This achieves the result that a minimum provided force of pressure is always maintained within stacks 2. This minimum force of pressure thus exists over the entire service life of battery module 1.

In the event of a shock load, e.g. if battery module 1 falls down, the force shock is absorbed solely within the individual stacks 2. In particular, no forces are transmitted from one battery cell 4 onto another battery cell 4. A mechanical overloading of individual battery cells 4 is thus avoided.

Battery module 1 is particularly advantageously a battery module for electrically driven bicycles. Battery module 1 is particularly suitable for use in bicycles due to the optimized shock resistance.

What is claimed is:

1. A battery module, comprising:
a plurality of stacks, each respective stack of the stacks includes at least one cell holder and multiple battery cells, each respective cell holder of the cell holders is configured to accommodate the battery cells of the respective stack, pressing elements on opposite end faces of the each respective cell holder abut both on the respective cell holder and on the battery cells of the respective cell holder and exert a force of pressure at least on the battery cells of the respective cell holder along a pressing direction, the stacks are arranged adjoining along the pressing direction and are press-fitted along the pressing direction.

2. The battery module as recited in claim 1, wherein a stiffness of each respective cell holder along the pressing direction is greater than a stiffness of the battery cells of the respective cell holder along the pressing direction.

3. The battery module as recited in claim 1, wherein the pressing elements respectively have at least one first area and one second area, the respective cell holder abutting only on the first area of the pressing elements and the battery cells of the respective cell holder abutting only on the second area of the pressing elements and the first area having a greater stiffness than the second area.

4. The battery module as recited in claim 3, wherein the pressing elements are respectively configured in such a way that the second area exerts an elastic restoring force on the battery cells of the respective cell holder when the first area abuts on the respective cell holder.

5. The battery module as recited in claim 3, wherein only the first area abuts on an adjacent stack.

6. The battery module as recited in claim 3, wherein a pressing element of the pressing elements is arranged between two cell holders of two stacks, the pressing element including a first area and two second areas separated by the first area, and each second area of the two second areas is assigned to the battery cells of respectively one of the two stacks.

7. The battery module as recited in claim 3, wherein the first area has a recess, in which the second area is situated.

8. The battery module as recited in claim 1, wherein the pressing elements are each made of plastic.

9. The battery module as recited claim 1, further comprising:
a tension rod for press-fitting the stacks.

10. The battery module as recited in claim 9, wherein the tension rod extends between two end plates, the stacks being situated between the end plates.
